(19) United States
(12) Patent Application Publication
(10) Pub. No.: US 2019/0379024 A1
(43) Pub. Date: Dec. 12, 2019

(54) BUSBAR AND BUSBAR COUPLED BODY

(71) Applicant: SUMITOMO WIRING SYSTEMS, LTD., Mie (JP)

(72) Inventor: Koichiro MOCHIZUKI, Mie (JP)

(73) Assignee: SUMITOMO WIRING SYSTEMS, LTD., Mie (JP)

(21) Appl. No.: 16/423,625

(22) Filed: May 28, 2019

(30) Foreign Application Priority Data
Jun. 6, 2018 (JP) 2018-108706

(51) Int. Cl. H01M 2/20; H01B 5/02

(52) U.S. Cl. CPC H01M 2/202; H01B 5/02

(57) ABSTRACT

A burr of a busbar is prevented from interfering with the electrodes of a battery cell. A busbar includes: a flat plate portion having a back surface that is to be fixed to electrodes of a battery cell through welding, wherein a burr at an outer peripheral edge of the flat plate portion protrudes only toward a surface of the flat plate portion. A busbar coupled body A includes: a plurality of plate-shaped busbars that are disposed aligned at an interval; and a coupling portion that couples opposing edge portions of the adjacent busbars to each other, wherein a boundary between the coupling portion and each of the opposing edge portions is separated through pressing.

### TECHNICAL FIELD

The present invention relates to a busbar and a busbar coupled body.

### BACKGROUND ART

JP 2014-229585A discloses a structure in which the electrodes of adjacent battery cells are connected by a plate-shaped busbar, and the voltages of the electrodes are detected by connecting a voltage detection circuit to the busbar.

JP 2014-229585A is an example of related art.

### SUMMARY OF THE INVENTION

Possible methods for manufacturing busbars include a method that involves producing a long busbar coupled body having a configuration in which a plurality of busbars are coupled in the form of a chain via carriers, and sequentially separating the busbars from the carriers, while feeding the busbar coupled body forward. However, the carriers are discarded after the busbars have been separated therefrom, resulting in an increase in the cost of materials. In particular, when the busbar is made of a clad member obtained by fixing two metal plate members made of different materials such that they are flush with each other, the high cost of the clad member leads to a further increase in costs.

As a method for reducing the material cost, it is conceivable to produce a busbar coupled body having a configuration in which busbars are directly connected without using any carrier, and to sequentially separate the busbars using a cutter, while feeding the busbar coupled body forward. However, adjacent busbars are sheared at a portion cut by the cutter. Consequently, the protruding direction of a burr that occurs on the cut surface of one busbar and the protruding direction of a burr that occurs on the cut surface of the other busbar are opposite to each other. That is, a burr protruding toward the surface and burr protruding toward the back surface are present on a single busbar. Accordingly, there is concern that, when performing laser welding with a busbar being placed on the electrodes of a battery cell, the burr protruding toward the electrodes interferes with the electrodes, thus causing a welding failure.

The present invention has been completed in light of the above-described circumstances and its object is to prevent burr of a busbar from interfering with the electrodes of a battery cell.

A busbar according to a first aspect of the present invention includes: a flat plate portion having a back surface that is to be fixed to electrodes of a battery cell through welding, wherein burr at an outer peripheral edge of the flat plate portion protrudes only toward a surface of the flat plate portion.

A busbar coupled body according to a second aspect of the present invention includes: a plurality of plate-shaped busbars that can be fixed to electrodes of a battery cell through welding, and that are disposed aligned at an interval; and a coupling portion that couples opposing edge portions of the adjacent busbars to each other, wherein a boundary between the coupling portion and each of the opposing edge portions can be separated through pressing.

According to the first aspect of the present invention, the burr at the outer peripheral edge of the busbar protrudes only toward the surface, and, therefore, there is no possibility that the burr will interfere with the electrodes when performing welding with the busbar being placed on the electrodes of the battery cell.

According to the second aspect of the present invention, the opposing edge portions of two adjacent busbars are connected to one coupling portion. Accordingly, as a result of separating the coupling portion and each of the opposing edge portions of the busbars through pressing, a burr that occurs at each of the opposing edge portions of the busbars protrudes only toward one of the surface and the back surface. Consequently, when performing welding with the busbar being placed on the electrodes of a battery cell, the burr can be prevented from interfering with electrodes by placing the side of the busbar, toward which the burr does not protrude, on the electrodes.

### BRIEF DESCRIPTION OF THE DRAWINGS

FIG. 1 is a plan view of a busbar coupled body according to Embodiment 1;

FIG. 2 is a partial enlarged plan view of the busbar coupled body;

FIG. 3 is a partial enlarged plan view showing a state in which a coupling portion has been separated from busbars;

FIG. 4 is a perspective view of a busbar;

FIG. 5 is a plan view showing a state in which a busbar module to which a wire has not been connected is attached to a battery cell;

FIG. 6 is a rear view showing a state in which a busbar module to which a wire has not been connected is attached to a battery cell;

FIG. 7 is a partial enlarged rear view of FIG. 6; and

FIG. 8 is a plan view of the busbar module.

### EMBODIMENTS OF THE INVENTION

In the busbar according to the first aspect of the present invention, at the outer peripheral edge of the flat plate portion, a lightening portion may be formed having a configuration in which the outer peripheral edge is partly recessed, and the lightening portion may be disposed in a region that does not correspond to the electrodes. With this configuration, a large welding area to the electrodes can be ensured for the busbar, thus making it possible to increase the weld strength, while reducing the weight of the busbar.

In the busbar coupled body according to the second aspect of the present invention, a pilot hole for intermittently transporting the busbar coupled body may be formed in the coupling portion. With this configuration, it is possible to prevent abnormal shape change of the busbar.

In the busbar coupled body according to the second aspect of the present invention, the boundary between the coupling portion and each of the opposing edge portions may have a shape in which the opposing edge portion is partly recessed. With this configuration, as a result of separating the coupling portion and the busbar, a lightening portion is formed at each of the opposing edge portions of the busbar. Accordingly, it is possible to reduce the weight of the busbar.

In the busbar coupled body according to the second aspect of the present invention, a lightening portion that is formed at each of the opposing edge portions after separating the coupling portion may be disposed in a region that does not correspond to the electrodes. With this configuration, a large welding area to the electrodes can be ensured for the busbar, thus making it possible to increase the weld strength of, while reducing the weight of, the busbar.

### Embodiment 1

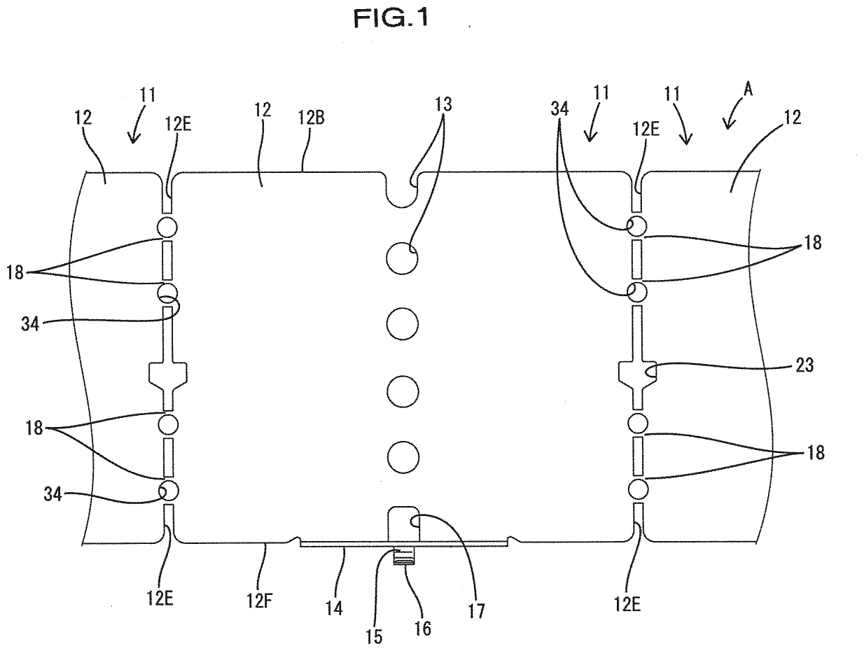

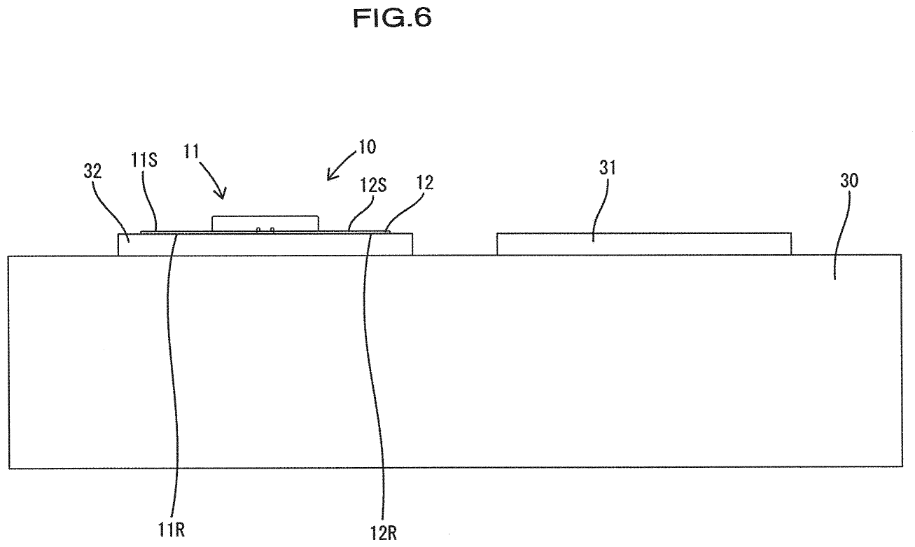

Hereinafter, Embodiment 1 of the present invention will be described with reference to FIGS. 1 to 8. In the following description, with respect to the front-rear direction, the lower side in FIGS. 1, 5 and 8 is defined as the front side.

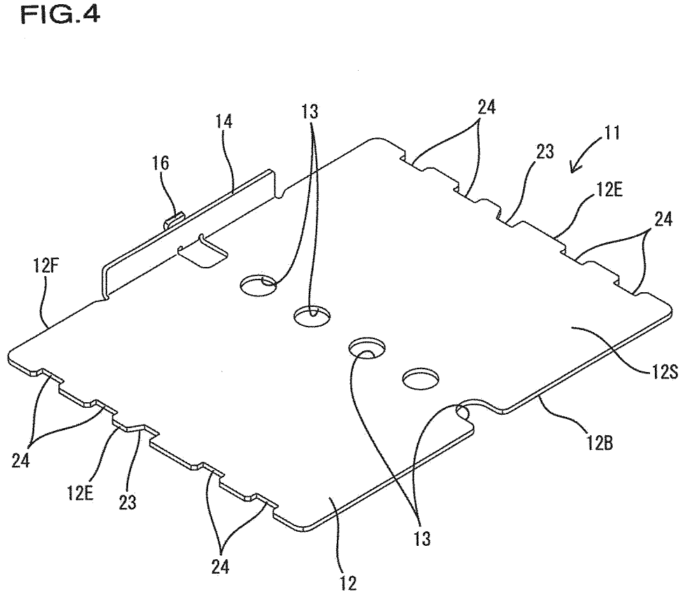

With respect to the up-down direction, the upper side and the lower side as shown in FIGS. 4, 6 and 7 are defined as the upper side and the lower side, respectively. With respect to the left-right direction, the left side and the right side as shown in FIGS. 1 to 3, 5, 6 and 8 are defined as the left side and the right side, respectively.

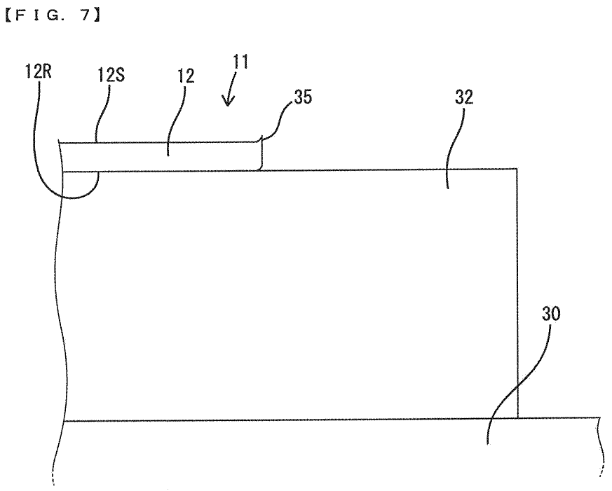

A busbar coupled body A according to Embodiment 1 is formed of a clad member having a configuration in which flat plate members of two types of metals (e.g., copper and aluminum) each having the shape of a band that is elongated in the left-right direction are fixed flush with each other and arranged one in the front-rear direction. The busbar coupled body A is formed by punching the clad member into a predetermined shape using a pressing machine (not shown), and then bending the punched clad member. During pressing, the busbar coupled body A is cut such that a burr 35 (see FIG. 7) occurs only on the surface side thereof.

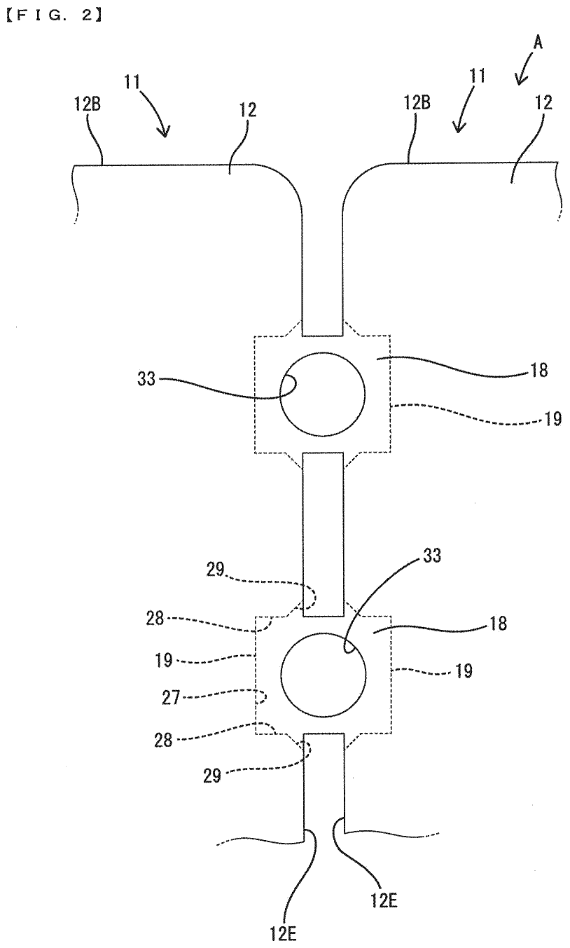

As shown in FIGS. 1 and 2, the busbar coupled body A that has been cut into a predetermined shape is a single long chain-shaped member including a plurality of busbars 11 that are aligned in the left-right direction at intervals of a constant pitch, and a plurality of coupling portions 18 that couple the adjacent busbars 11 to each other. The busbar coupled body A is linearly pulled out from a state in which it is wound on a reel (not shown). In the process in which the busbar coupled body A is pulled out, a boundary 19 between each coupling portion 18 and the busbars 11 is sheared by a pressing machine (not shown). By shearing the boundaries 19 between the coupling portions 18 and the busbars 11, busbars 11 having a predetermined shape are taken out, and the coupling portions 18 are discarded.

Each busbar 11 has a substantially square plan-view shape. The busbar 11 includes a flat plate portion 12 having a substantially square plan-view shape, a support wall portion 14 standing up at a substantially right angle from a front edge portion 12F of the flat plate portion 12 toward a surface 12S, and one barrel portion 16. The burr 35 protrudes only toward the surface 12S of the flat plate portion 12 in the entire region of the outer peripheral edge of the flat plate portion 12, i.e., the front edge portion 12F, a rear edge portion 12B, and laterally opposite side edge portions (opposing edge portions 12E).

At the front edge portion of the flat plate portion 12, a lanced portion 15 is formed by lancing a portion of the flat plate portion 12 toward the back surface 12R, and inverting that portion forward of the support wall portion 14. The inverted lanced portion 15 is further bent upward, thus forming a barrel portion 16 that is opposed to the front surface of the support wall portion 14. In the process of lancing the barrel portion 16 (lanced portion 15), a lanced hole 17 in the form of a through hole is formed in the flat plate portion 12 in a region thereof in which the lanced portion 15 has been present. At the opening edge of the lanced hole 17, the burr 35 protrudes toward the surface 12S of the flat plate portion 12 (see FIG. 7).

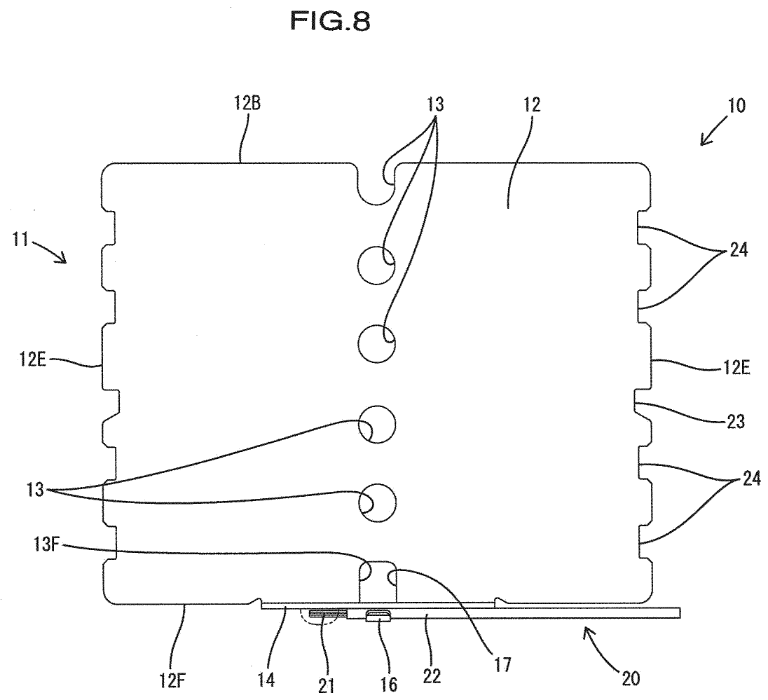

As shown in FIG. 8, a wire 20 is attached between the inner circumferential surface (the back surface 12R of the flat plate portion 12) of the barrel portion 16 and the front surface (the back surface 12R of the flat plate portion 12) of the support wall portion 14. The wire 20 is a coated wire formed by surrounding a core wire 21 made of a stranded metal wire with an insulating coating 22 made of a synthetic resin. The terminal end portion of the wire 20 has been subjected in advance to terminal end processing in which the insulating coating 22 is removed by a predetermined length such that the terminal end portion of the core wire 21 is exposed.

Of the terminal end portion of the wire 20, the portion surrounded by the insulating coating 22 is fixed in a state in which it is sandwiched between the barrel portion 16 and the support wall portion 14. The core wire 21 is disposed in proximity to a region of the support wall portion 14 that is adjacent to the barrel portion 16, and is conductively fixed through welding. Thus, the wire 20 is attached to the busbar 11, and the busbar 11 and the wire 20 constitute a busbar module 10. The wire 20 is connected to a voltage detection circuit (not shown) or the like via the busbar 11.

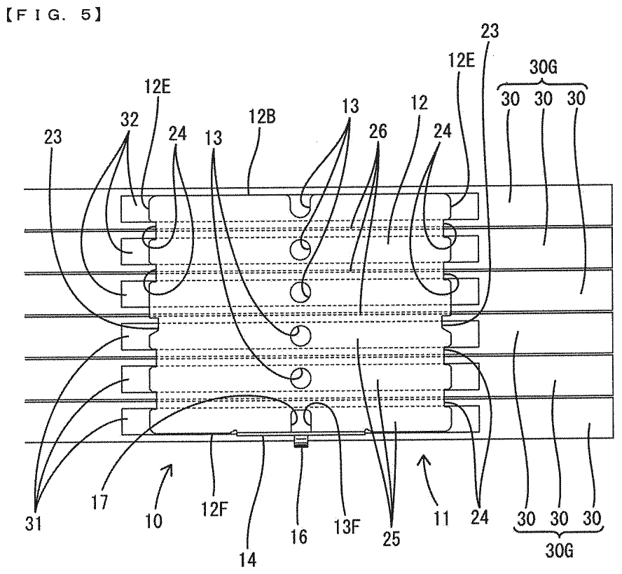

The busbar module 10 (the flat plate portion 12 of the busbar 11) is configured to be fixed to electrodes 31 and 32 of battery cells 30. As shown in FIG. 5, the plan-view shape of the upper surface of the battery cells 30 is a substantially rectangular shape that is long in the left-right direction. On the upper surface of each of the battery cells 30, a positive (+) electrode 31 protruding in the form of a rib extending in the left-right direction, and a negative (−) electrode 32 also protruding in the form of a rib extending in the left-right direction are provided at an interval in the left-right direction.

A plurality of battery cells 30 are disposed arranged at a constant pitch in the front-rear direction, and three battery cells 30 arranged in the front-rear direction constitute one cell group 30G. A plurality of cell groups 30G are disposed arranged in the front-rear direction, and the positions of the positive (+) electrode 31 and the negative (−) electrode 32 are laterally reversed between the cell groups 30G that are adjacent to each other in the front-rear direction.

The busbar modules 10 are disposed arranged in the front-rear direction with the flat plate portions 12 of the busbars 11 facing in the horizontal direction. A single busbar 11 conductively connects the positive (+) electrode 31 and the negative (−) electrode 32 of two cell groups 30G that are adjacent to each other in the front-rear direction. That is, a front end region of the back surface 12R of the flat plate portion 12 is placed on the upper surfaces of the three positive (+) electrodes 31 of the front cell group 30G, and is conductively fixed to the positive (+) electrodes 31 through laser welding. The rear end region of the back surface 12R of the flat plate portion 12 is placed on the upper surfaces of the three negative (−) electrodes 32 of the rear cell group 30G, and is conductively fixed to the negative (−) electrodes 32 through laser welding.

Six through holes 13 and 13F extending from the back surface 12R of the flat plate portion 12 through the surface 12S are formed at intervals in the front-rear direction at the central position of the flat plate portion 12 in the left-right direction. As will be described below, in a state in which the flat plate portion 12 is connected to the upper surfaces of the electrodes 31 and 32, the through holes 13 and 13F are disposed such that the upper surfaces of the electrodes 31 and 32 are partly exposed.

Five lightening portions 23 and 24 arranged at intervals in the front-rear direction are formed at each of the laterally opposite side edge portions of the flat plate portion 12. In Embodiment 1, the laterally opposite side edge portions of the flat plate portion 12 are defined as opposing edge portions 12E of the outer peripheral edge of a busbar 11 that are opposed to busbars 11 laterally adjacent thereto in a state in which the busbars 11 constitute the busbar coupled body A. The five lightening portions 23 and 24, in a plan view, each have a shape in which the opposing edge portion 12E is partly recessed.

Of the five lightening portions 23 and 24, a first lightening portion 23 located at the center in the front-rear direction already has been formed in a state in which the busbars 11 are coupled by the coupling portions 18 and constitute the busbar coupled body A. In contrast, of the five lightening portions 23 and 24, second lightening portions 24 (the lightening portion described in the claims), which are the four lightening portions 24 other than the first lightening portion 23, have not been formed in a state in which the busbars 11 are coupled by the coupling portions 18 and constitute the busbar coupled body A, but are formed after the coupling portions 18 and the busbars 11 have been separated in the pressing process.

As shown in FIG. 5, regions (regions coming into contact with the upper surfaces of the electrodes 31 and 32) of the busbar 11 (the flat plate portion 12) that correspond to the electrodes 31 and 32 in the front-rear direction are welding target regions 25 that are to be welded to the electrodes 31 and 32 across the entirety of the left-right direction. Regions (regions displaced from the electrodes 31 and 32) of the busbar 11 (the flat plate portion 12) that do not correspond to the electrodes 31 and 32 in the front-rear direction are non-welded regions 26 that are not to be welded to the electrodes 31 and 32 and do not come into contact with the electrodes 31 and 32. Since all of the four second lightening portions 24 are disposed in the non-welded regions 26, the width dimension (the dimension of the electrodes 31 and 32 in the length direction) of the welding target regions 25 of the busbar 11 (the flat plate portion 12) is larger than the width dimension of the non-welded regions 26.

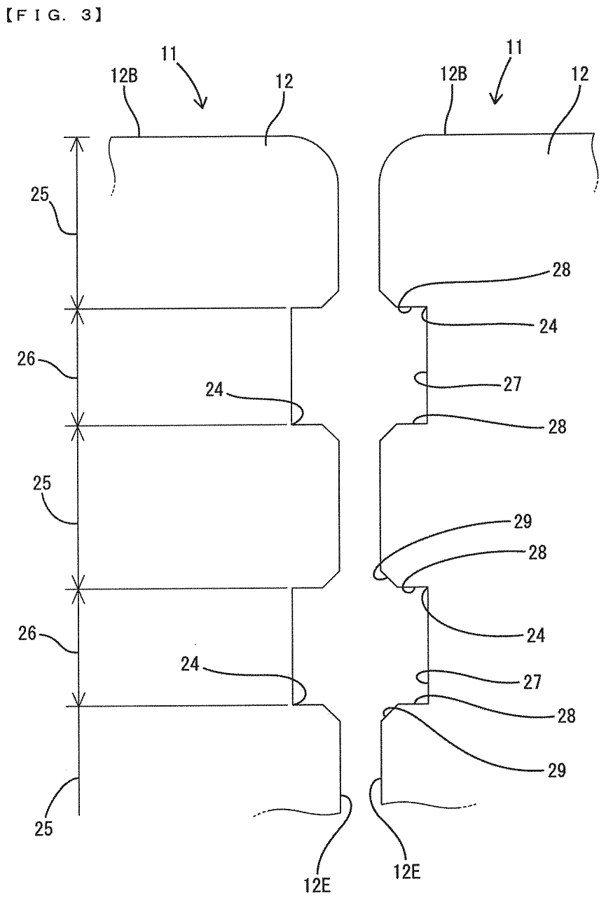

The plan-view shape of the second lightening portions 24 is a substantially square shape. More specifically, as shown in FIGS. 2 and 3, the opening edge of each second lightening portion 24 is composed of a first edge portion 27 extending in the front-rear direction and parallel to the opposing edge portion 12E, a pair of second edge portions 28 forming a right angle with the front and rear edges, respectively, of the first edge portion 27, and third edge portions 29 connecting the respective second edge portions 28 with the opposing edge portion 12E. The third edge portions 29 are inclined relative to the opposing edge portion 12E and the second edge portions 28.

In a state in which the busbars 11 constitute the busbar coupled body A, laterally adjacent busbars 11 are coupled via four coupling portions 18. In the front-rear direction, four coupling portions 18 are disposed at the same position as the four second lightening portions 24. The laterally opposite end portions of the coupling portion 18 are present in regions that will form the second lightening portions 24 when the busbars 11 have been separated from the coupling portions 18.

When separating the coupling portions 18 from the busbar 11, a pressing mold (not shown) having a plan-view shape that follows the first edge portion 27, the second edge portions 28, and the third edge portions 29 is used. That is, the first edge portion 27, the second edge portions 28, and the third edge portions 29 constitute a boundary 19 between the busbar 11 and the coupling portion 18. As a result of the coupling portion 18 being separated from the busbar 11 using the pressing mold, a second lightening portion 24 is formed. Since the pressing mold presses the coupling portion 18 upward from the back surface 11R side of the busbar 11 (the flat plate portion 12), a burr 35 that occurs in the region in which each second lightening portion 24 is formed (the first edge portion 27, the second edge portions 28, and the third edge portions 29) of the outer peripheral edge of the busbar 11 protrudes toward the surface 11S of the busbar 11 (the flat plate portion 12) as with the front edge portion 12F, the rear edge portion 12B, and the opposing edge portion 12E of the busbar 11 (the flat plate portion 12).

As shown in FIG. 1, a pilot hole 34 is formed in each of the coupling portions 18. When intermittently transporting the busbar coupled body A to the pressing mold by a transport device (not shown), feed pawls (not shown) of the transport device engage with the pilot holes 34. Since the pilot holes 34 are formed in the coupling portions 18, rather than in the busbar 11, there is no possibility that the busbar 11 will be damaged or be subjected to abnormal shape change by the feed pawls.

The busbar coupled body A according to Embodiment 1 has a configuration in which a plurality of busbars 11 having a substantially plate shape and a plurality of sets of coupling portions 18 having a plate shape are alternately connected. The plurality of busbars 11 are disposed aligned in the left-right direction at intervals. The plurality of sets of coupling portions 18 couple the opposing edge portions 12E of adjacent busbars 11 to each other. The boundary 19 between each coupling portion 18 and the opposing edge portions 12E can be separated through pressing.

As a result of separating the boundary 19 between each coupling portion 18 and the opposing edge portions 12E through pressing, a coupling portion 18 and a busbar 11 that has been separated from another busbar 11 are obtained. Each of the busbars 11 has a flat plate portion 12, and a back surface 12R of the flat plate portion 12 is fixed to electrodes 31 and 32 of a battery cell 30 through welding. A burr 35 at the outer peripheral edge of the flat plate portion 12 protrudes only toward the surface 12S of the flat plate portion 12.

In the busbar coupled body A, the opposing edge portions 12E of two busbars 11 that are adjacent to one coupling portion 18 are connected. Accordingly, as a result of separating the coupling portion 18 from the opposing edge portions 12E through pressing, the burrs 35 that occur at the opposing edge portions 12E protrude only toward the surface 12S of the flat plate portion 12. Consequently, when performing welding with the busbar 11 being placed on the electrodes 31 and 32 of the battery cell 30, the burrs 35 can be prevented from interfering with the electrodes 31 and 32 by placing the back surface 12R, toward which the burrs 35 do not protrude, of the busbar 11 on the electrodes 31 and 32.

The boundary 19 of each coupling portion 18 with each of the opposing edge portions 12E has a shape in which the opposing edge portion 12E is partly recessed. Accordingly, as a result of separating the coupling portion 18 and the busbar 11, a second lightening portion 24 is formed on each of the opposing edge portions 12E. That is, at the outer peripheral edge of the flat plate portion 12, a second lightening portion 24 is formed having a configuration in which the outer peripheral edge is partly recessed. The weight reduction of the busbar 11 is achieved by forming the second lightening portion 24.

The second lightening portions 24, which are formed in each of the opposing edge portions 12E after the coupling portion 18 are separated, are disposed in the non-welded regions 26 that do not correspond to the electrodes 31 and 32. Accordingly, a large welding area to the electrodes 31 and 32 can be ensured for the busbar 11. Accordingly, it is possible to reduce the weight of the busbar 11, while increasing the weld strength.

### Other Embodiments

The present invention is not limited to the embodiment described by the above statements and drawings, and, for example, the following embodiments also fall within the technical scope of the present invention.

(1) In Embodiment 1 above, the lightening portions are formed at the opposing edge portions (outer peripheral edges) of the busbar; however, the opposing edge portions may also be formed linearly over the entire length, without forming any lightening portion at the opposing edge portions of the busbar.

(2) In Embodiment 1 above, the lightening portions are disposed in the regions that do not correspond to the electrodes; however, the lightening portions may also be disposed in the regions that correspond to the electrodes.

(3) In Embodiment 1 above, only four of the five lightening portions formed at each of the opposing edge portions are formed by separating the coupling portions; however, the number of lightening portions formed at one opposing edge portion by separating the coupling portions may also be three or less, or may also be five (i.e., all lightening portions).

(4) In Embodiment 1 above, five lightening portions are formed at each of the opposing edge portions of the busbar; however, the number of lightening portions formed at one opposing edge portion may also be four or less, or may also be six or more.

(5) In Embodiment 1 above, the pilot holes are formed in the coupling portions; however, the pilot holes may also be formed in the busbar.

### LIST OF REFERENCE NUMERALS

A: Busbar coupled body

11: Busbar

12: Flat plate portion

12S: Surface

12R: Back surface

12E: Opposing edge portion

18: Coupling portion

19: Boundary

24: Second lightening portion (lightening portion)

26: Non-welded region (region that does not correspond to electrode)

30: Battery cell

31, 32: Electrode

34: Pilot hole

35: Burr

What is claimed is:

1. A busbar comprising:
a flat plate portion having a back surface configured to be fixed to electrodes of a battery cell through welding,
wherein a burr at an outer peripheral edge of the flat plate portion protrudes only toward a surface of the flat plate portion opposite to the back surface.

2. The busbar according to claim 1,
wherein, at the outer peripheral edge of the flat plate portion, a lightening portion is formed having a configuration in which the outer peripheral edge is partly recessed, and
the lightening portion is disposed in a region that does not correspond to the electrodes.

3. A busbar coupled body comprising:
a plurality of plate-shaped busbars configured to be fixed to electrodes of a battery cell through welding, and that are disposed aligned at an interval; and
a coupling portion that couples opposing edge portions of the adjacent busbars to each other,
wherein a boundary between the coupling portion and each of the opposing edge portions is configured to be separated through pressing.

4. The busbar coupled body according to claim 3,
wherein a pilot hole for intermittently transporting the busbar coupled body is formed in the coupling portion.

5. The busbar coupled body according to claim 3,
wherein the boundary between the coupling portion and each of the opposing edge portions has a shape in which the opposing edge portion is partly recessed.

6. The busbar coupled body according to claim 5,
wherein a lightening portion formed at each of the opposing edge portions after separating the coupling portion is disposed in a region that does not correspond to the electrodes.
